(19) United States
(12) Patent Application Publication
(10) Pub. No.: US 2025/0279217 A1
(43) Pub. Date: Sep. 4, 2025

(54) METHOD AND SYSTEM FOR CONTROLLING A NUCLEAR POWER PLANT

(71) Applicant: FRAMATOME, COURBEVOIE (FR)

(72) Inventor: Jean FEINGOLD, MONTROUGE (FR)

(21) Appl. No.: 18/281,608

(22) PCT Filed: Mar. 11, 2022
(86) PCT No.: PCT/EP2022/056298

§ 371 Date: Feb. 25, 2024

(30) Foreign Application Priority Data
Mar. 12, 2021 (FR) FR2102457

(51) Int. Cl. G21D 3/00

(52) U.S. Cl. CPC G21D 3/007; G21D 3/001

(57) ABSTRACT

A control method and system for controlling a nuclear power plant includes, in the absence of detection of an imbalance between a primary power signal (S1) and a secondary power signal (S2), the implementation of a setpoint-following mode. The nuclear power plant is controlled as a function of an operational power setpoint (COP), and in the event of detection of an imbalance, automatically implementing a power-limiting mode, including the calculation of a target equilibrium power (PEC) less than or equal to the primary power (P1) and less than or equal to the secondary power (P2), and controlling the nuclear power plant (2) as a function of the target equilibrium power (PEC).

The present disclosure further relates to a method for controlling a nuclear power plant.

### BACKGROUND

A nuclear power plant has a separate primary and secondary water circuit, a nuclear reactor to heat the water circulating in the primary circuit, one or more steam generators thermally coupling the primary and secondary circuits to transfer heat from the primary circuit to the secondary circuit and produce steam in the secondary circuit, and a steam turbine integrated into the secondary circuit to generate mechanical energy from the steam. This mechanical energy can then be converted into electrical energy using an electrical generator coupled to the steam turbine.

### SUMMARY

One of the aims of the present disclosure is to propose a method for controlling a nuclear power plant which enables the nuclear power plant to be maintained in a satisfactory operating range, preferably usable over a wide range of nuclear reactor power levels.

To this end, the present disclosure proposes a method for controlling a pressurised water nuclear power plant implemented by an automated control system, the nuclear power plant comprising a primary circuit for circulating water, incorporating a nuclear reactor, a secondary circuit for circulating water, and N steam generator(s), N being an integer greater than or equal to 1, each steam generator being configured to transfer thermal energy from the primary circuit to the secondary circuit with steam being generated in the secondary circuit, the control method comprising:
calculating a primary power representative of the thermal power generated by the nuclear reactor and a secondary power representative of the thermal power transferred from the primary circuit to the secondary circuit by the steam generator(s),
detecting any imbalance between, on the one hand, a primary power signal calculated as a function of the primary power and/or at least one variable indicative of a variation in the primary power and, on the other hand, a secondary power signal calculated as a function of the secondary power and/or at least one variable indicative of a variation in the secondary power,
in the absence of detection of an imbalance, implementing a setpoint-following mode, wherein the nuclear power plant is controlled as a function of an operational power setpoint received by the control system so that the primary power and the secondary power follow the operational power setpoint; and
if an imbalance is detected, automatically implementing a power-limiting mode, comprising calculation, by the control system, of a target equilibrium power less than or equal to the primary power and less than or equal to the secondary power, and control of the nuclear power plant as a function of the target equilibrium power.

According to particular embodiments, the control method has one or more of the following features taken individually or in any combination that is technically possible:
the secondary power is determined by calculating the thermal power transferred by each steam generator from the primary circuit to the secondary circuit and by calculating the sum of these thermal powers;
the primary power signal is calculated as a function of the primary power, a filtered derivative of the primary power, an axial offset of the nuclear reactor, a filtered derivative of the axial offset of the nuclear reactor, a control cluster motion signal and/or a filtered derivative of the control cluster motion signal;
the primary power signal is calculated as the sum of the primary power and one or more of the filtered derivative of the primary power multiplied by a primary power coefficient, the absolute value of the filtered derivative of the axial offset multiplied by an axial offset coefficient, and the filtered derivative of the control cluster motion signal multiplied by a motion signal coefficient;
the secondary power signal is calculated as a function of the secondary power, a steam pressure representative of the steam pressure at the outlet of the steam generator(s), a filtered derivative of the steam pressure, a feedwater temperature representative of the water temperature at the inlet of the steam generator(s), a filtered derivative of the feedwater temperature, a feedwater flow rate representative of the feedwater flow rate at the inlet of the steam generator(s), and/or a filtered derivative of the feedwater flow rate;
the secondary power signal is calculated as the sum of the secondary power and one or more of the filtered derivative of steam pressure multiplied by a steam pressure coefficient, the filtered derivative of the feedwater temperature multiplied by a feedwater temperature coefficient, and the filtered derivative of feedwater flow multiplied by a feedwater flow coefficient;
detecting any imbalance comprises comparing a difference between the primary power signal and the secondary power signal with a lower threshold and/or an upper threshold;
detecting any imbalance comprises the generating of a logic signal requesting rebalancing when said difference is less than the lower threshold and/or greater than the upper threshold, ordering a switch to the power-limiting mode;
the power-limiting mode is activated for a power-limiting time determined from the detection of an imbalance;
the target equilibrium power is calculated as a function of a maximum equilibrium power, the target equilibrium power being less than or equal to the maximum equilibrium power;
the maximum equilibrium power is calculated as a function of the primary power reduced by a non-zero difference;
the primary power reduced by the difference is filtered so that the absolute value of its derivative remains below a determined derivative threshold;
the control method comprises clipping in such a way that the maximum equilibrium power is less than a determined maximum value and/or greater than a determined minimum value;
the target equilibrium power is determined as the lowest among the primary power, the secondary power and the maximum equilibrium power;
the control method comprises, in the power-limiting mode, calculating a primary power setpoint and a secondary power setpoint as a function of the target equilibrium power, and controlling the nuclear power plant in such a way that the primary power matches the primary power setpoint and the secondary power matches the secondary power setpoint;
in power-limiting mode, the primary power setpoint is calculated as equal to the target equilibrium power, optionally filtered, preferably by a low-pass filter, and the secondary power setpoint is calculated as equal to the target equilibrium power, optionally filtered, preferably by a low-pass filter.

The present disclosure also relates to a nuclear power plant control system configured to implement a control method as defined above.

To this end, the present disclosure also relates to a the nuclear power plant comprising a primary circuit for circulating water, incorporating a nuclear reactor, a secondary circuit for circulating water, and N steam generator(s), N being an integer greater than or equal to 1, each steam generator being configured to transfer thermal energy from the primary circuit to the secondary circuit with steam being generated in the secondary circuit, the nuclear power plant comprising a control system as defined above.

The present disclosure also relates to a computer program product that can be recorded on a computer medium or in a computer memory and can be executed by a processor, said computer program product containing software code instructions for implementing a control method as defined above.

### BRIEF DESCRIPTION OF THE DRAWINGS

The present disclosure and its advantages will become apparent upon reading the following description, given only as a nonlimiting example, referring to the attached drawings, in which:

FIG. 1 is a schematic view of a nuclear power plant, illustrating a primary circuit, incorporating a nuclear reactor, and a secondary circuit;

FIGS. 2 to 6 are block diagrams illustrating a method for controlling the nuclear power plant shown in FIG. 1;

FIG. 7 is a schematic view of a nuclear power plant in another embodiment;

FIG. 8 is a schematic view of a nuclear power plant in yet another embodiment.

### DETAILED DESCRIPTION

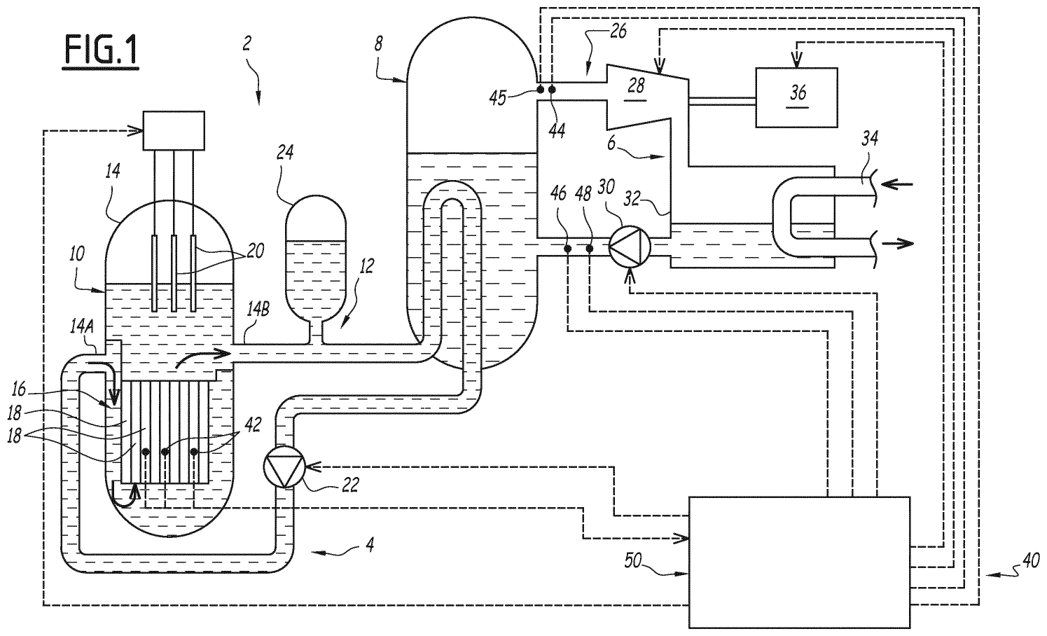

The nuclear power plant 2 illustrated in FIG. 1 comprises a primary circuit 4 for the circulation of water and a secondary circuit 6 for the circulation of water, the primary circuit 4 and the secondary circuit 6 being separate and thermally coupled via N steam generator(s) 8, N being an integer greater than or equal to 1.

Each steam generator 8 is arranged between the primary circuit 4 and the secondary circuit 6 and configured for heat exchange between the water in the primary circuit 4 and the water in the secondary circuit 6.

In operation, each steam generator 8 generates steam in the secondary circuit 6. In the secondary circuit 6, each steam generator 8 is supplied at the inlet with water in a liquid state and supplies at the outlet water in a gaseous state, i.e. steam.

The primary circuit 4 comprises a nuclear reactor 10 for heating the water circulating in the primary circuit 4.

The nuclear power plant 2 is, for example, a pressurised water nuclear power plant, in which case the nuclear reactor 10 is a pressurised water reactor (PWR), or a boiling water nuclear power plant, in which case the nuclear reactor 10 is a boiling water reactor (BWR).

The primary circuit 4 comprises, for example, N fluidic primary loop(s) 12, each primary loop 12 fluidically connecting the nuclear reactor 10 to a respective steam generator 8.

A single steam generator 8 and a single primary loop 12 are shown in FIG. 1. Alternatively, the primary circuit 4 comprises a plurality of primary loops 12, for example four primary loops 12.

The nuclear reactor 10 comprises a reactor vessel 14. Each primary loop 12 connects the reactor vessel 14 to a respective steam generator 8. Each primary loop 12 is connected to the reactor vessel 14 by an inlet pipe 14A and an outlet pipe 14B.

The nuclear reactor 10 comprises a core 16 formed by a plurality of nuclear fuel assemblies 18 arranged side by side in the reactor vessel 14.

The nuclear reactor 10 includes control clusters 20 that can be lowered into or raised out of the reactor core 16 to control the reactivity of the nuclear reactor 10.

The control clusters 20 comprise, for example, regulating clusters which can be selectively inserted into the core 16 to reduce reactivity or extracted from the core 16 to increase reactivity, and safety clusters which can be released into the core 16 to cause an automatic shutdown of the nuclear reactor 10.

Each primary loop 12 comprises a respective primary pump 22 to force the circulation of water within this primary loop 12.

When the nuclear power plant 2 is a pressurised water nuclear power plant, the primary circuit 4 comprises a pressuriser 24 configured to maintain, in the primary circuit 4, a sufficient pressure so that the water circulating in the primary circuit 4 remains in the liquid state.

The pressuriser 24 is fluidically connected to a hot leg of a primary loop 12, i.e. a leg in which the fluid flows from the nuclear reactor 10 to the steam generator 8 located on this primary loop 12.

When the primary circuit 4 comprises several primary loops 12, the primary circuit 4 comprises, for example, a single pressuriser 24 connected to the hot leg of one of the primary loops 12.

The secondary circuit 6 comprises, for example, a single secondary loop 26 supplied with steam from the steam generator 8 of each primary loop 12.

Alternatively, the secondary circuit 6 comprises a respective secondary loop 26 associated with each primary loop 12 and supplied with steam from the steam generator 8 of this primary loop 12.

The secondary circuit 6 comprises one or more turbine(s) 28, each turbine 28 being configured to convert the thermal energy contained in the steam circulating in secondary circuit 6 into mechanical energy.

The secondary circuit 6 comprises one or more secondary pumps 30 to force the circulation of water inside the secondary circuit 6.

The secondary circuit 6 comprises one or more condensers 32, each condenser 32 being arranged downstream of a turbine 28 to cool the steam exiting the turbine 28 and return it to the liquid state.

Each condenser 32 is arranged on the secondary circuit 6, for example, and is configured for heat exchange between the water in the secondary circuit 6 and the water circulating in a cooling circuit 34.

The nuclear power plant 2 comprises one or more electrical generators 36, each electrical generator 36 being mechanically coupled to a turbine 28 so as to generate electrical energy from the mechanical energy generated by this turbine 28. The electrical energy is supplied to an electricity distribution grid, for example.

The nuclear power plant 2 comprises a control system 40 configured for automatically controlling the nuclear power plant 2, in particular for implementing a method for controlling the nuclear power plant 2

The control system 40 comprises first sensors for measuring first operating parameters of the nuclear power plant 2, relating to the operation of the primary circuit 4, and second sensors for measuring second operating parameters of the nuclear power plant 2, relating to the operation of the secondary circuit 6.

The first sensors comprise, for example, neutron detectors 42 for measuring a neutron flux in the nuclear reactor 10.

The neutron detectors 42 comprise internal neutron detectors disposed inside the reactor core 16 (generally referred to as “incore” detectors) and/or external neutron detectors (not shown) disposed outside the reactor vessel 14 of the nuclear reactor 10 inside which the core 16 is housed (generally referred to as “excore” detectors).

The neutron detectors 42, for example, are self-powered neutron detectors (or SPNDs for short).

The neutron detectors 42 are, for example, cobalt, vanadium and/or rhodium detectors.

By measuring the neutron flux generated in the nuclear reactor 10 at a given time, it is possible to calculate a value that is representative of the instantaneous thermal power generated by the nuclear reactor 10, hereinafter referred to as the “primary power”.

The second sensors comprise, for example, for each steam generator 8, an outlet pressure sensor 44 for measuring the pressure in the secondary circuit 6 at the outlet of the steam generator 8, a steam flow rate sensor 45 for measuring the steam flow rate in the secondary circuit 6 at the outlet of the steam generator 8, an incoming water flow rate sensor 46 for measuring the flow rate of water entering the steam generator 8 in the liquid state in the secondary circuit 6, and/or an incoming water temperature sensor 48 for measuring the temperature of the water at the inlet of the steam generator 8 in the secondary circuit 6.

Direct or indirect measurements of the pressure of the steam exiting the steam generator 8, of the flow of steam exiting the steam generator 8, of the flow of water entering the steam generator 8 and/or of the temperature of the water entering the steam generator 8 at a given instant make it possible to calculate a value representative of the instantaneous thermal power transferred by the steam generator 8 from the primary circuit 4 to the secondary circuit 6.

The control system 40 comprises an electronic control unit 50 configured to monitor and control the nuclear power plant 2 by implementing the control-command method.

The electronic control unit 50 is configured, for example, to receive the first operating parameters and the second operating parameters, by receiving the measurement signals supplied by the first sensors and the second sensors.

The electronic control unit 50 is configured, for example, to control the primary circuit 4 and the secondary circuit 6 as a function of the first and second parameters.

The electronic control unit 50 is configured, for example, to control the control clusters 20 to adjust the reactivity of the nuclear reactor and/or each primary pump 22 to adjust the flow of water in the primary circuit 4, and/or to control each secondary pump 30 to adjust the flow of water in the secondary circuit 6 and to control each turbine 28 and/or each generator 36.

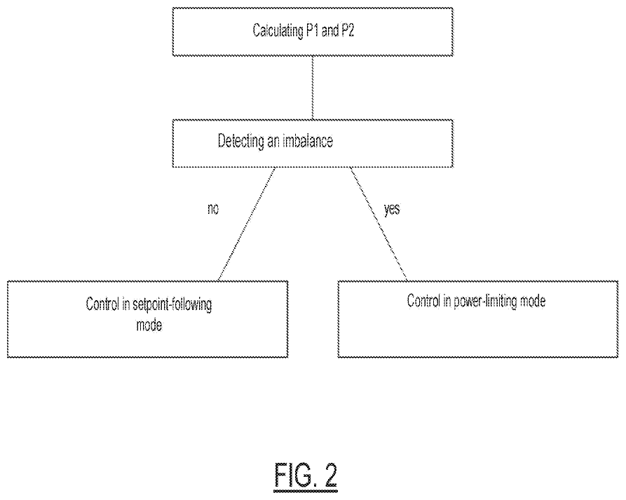

As illustrated in FIG. 2, the control method comprises:
calculating a primary power P1 representative of the thermal power generated by the nuclear reactor 10 and a secondary power P2 representative of the thermal power transferred from the primary circuit 4 to the secondary circuit 6 by the steam generator(s) 8,
detecting any imbalance between, on the one hand, a primary power signal S1 calculated as a function of the primary power P1 and/or at least one variable indicative of a variation in the primary power P1 and, on the other hand, a secondary power signal S2 calculated as a function of the secondary power P2 and/or at least one variable indicative of a variation in the secondary power P2,
in the absence of detection of an imbalance, implementing a setpoint-following mode, wherein the nuclear power plant 10 is controlled as a function of an operational power setpoint COP received by the control system 40 so that the primary power P1 and the secondary power P2 follow the operational power setpoint COP; and
if an imbalance is detected, automatically implementing a power-limiting mode, comprising calculation, by the control system 40, of a target equilibrium power PEC less than or equal to the primary power P1 and less than or equal to the secondary power P2, and control of the nuclear power plant 2 as a function of the target equilibrium power PEC.

The primary power P1 is calculated for example as a function of measurements of the first operating parameters of the nuclear power plant 2, relating to the operation of the primary circuit 4 and measured by the first sensors, in particular as a function of a measurement of the neutron flux in the core 16 of the nuclear reactor 10.

Measurements of the first parameters are provided by the first sensors, for example by the neutron detectors 42 fitted to the nuclear reactor 10.

The secondary power P2 is calculated, for example, as a function of second operating parameters of the nuclear power plant 2, relating to the operation of the secondary circuit 6 and measured by the second sensors.

The secondary power P2 is calculated, for example, by determining, for each steam generator 8 respectively, the thermal power transferred from the primary circuit 4 to the secondary circuit 6 by this steam generator 8, and by calculating the secondary power P2 as the sum of the transferred powers.

For each steam generator 8, the power transferred from the primary circuit 4 to the secondary circuit 6 is calculated in a known manner, for example as a function of the second parameters, in particular as a function of the steam pressure exiting the steam generator 8 in the secondary circuit 6, the steam flow rate exiting the steam generator 8 in the secondary circuit 6, the water flow rate entering the steam generator 8 in the secondary circuit 6 and/or the temperature of the water entering the steam generator 8 in the secondary circuit 6.

The measurements of the second parameters are, for example, provided respectively by the outlet pressure sensor 44, by the steam flow sensor 45, by the incoming water flow sensor 46 and/or by the incoming water temperature sensor 48.

The measurements of the second parameters are in another example respectively provided by the outlet pressure sensor 44, by a steam drum pressure sensor (not shown) arranged to measure the pressure of the steam in a steam drum of the secondary circuit, by the incoming water flow sensor 46 and by the incoming water temperature sensor 48.

In a secondary circuit 6 with a plurality of steam generators 8 supplying the same turbine 28, the steam drum is a collector receiving the steam produced by the steam generators 8 and distributing the steam produced to the turbine 28.

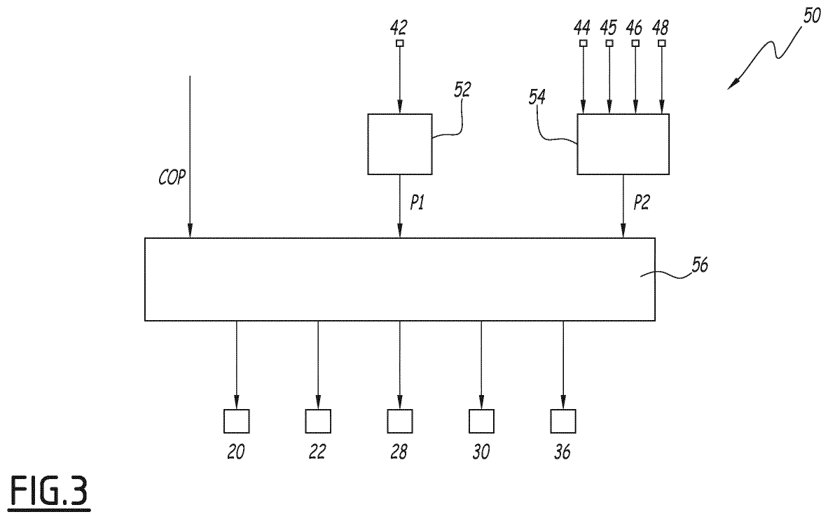

As illustrated in FIG. 3, the electronic control unit 50 comprises, for example, a primary power calculation module 52 for calculating the primary power P1 generated by the nuclear reactor 10 and a secondary power calculation module 54 for calculating the secondary power P2 transferred from the primary circuit 4 to the secondary circuit 6.

The primary power calculation module 52 receives, for example, the measurement signals provided by the neutron detectors 42, and the secondary power calculation module 54 receives, for example, the measurement signals provided by the outlet pressure sensor 44 measuring the pressure in the secondary circuit 6 at the outlet of the steam generator 8, by the steam flow sensor 45 measuring the steam flow rate in the secondary circuit 6 at the outlet of the steam generator 8, by the incoming water flow sensor 46 measuring the flow rate of water entering the steam generator 8 in the liquid state in the secondary circuit 6 and/or by the incoming water temperature sensor 48 measuring the temperature of the water at the inlet to the steam generator 8 in the secondary circuit 6.

The electronic control unit 50 comprises, for example, a control module 56 receiving the operational power setpoint COP, the calculated primary power P1 and the calculated secondary power P2, and is configured to generate instructions for the functional units of the nuclear power plant 2, enabling the nuclear power plant 2 to be controlled.

The control module 56 is configured, for example, to generate control instructions for the control clusters 20 for each primary pump 22, each turbine 28, each secondary pump 30 and/or each generator 36.

In the setpoint-following mode, the primary power P1 and the secondary power P2 are in principle balanced, the nuclear power plant 2 being controlled so as to keep the primary power P1 and the secondary power P2 each substantially equal to the operational power setpoint COP received by the control system 40.

The operational power setpoint COP is supplied, for example, by the operator that runs the nuclear power plant 2.

Optionally, it can be modified and/or modulated as a function of operating parameters of the electricity distribution grid to which the nuclear power plant 2 is connected, for example as a function of variations in the frequency of the electricity distribution grid.

During the operation of the nuclear power plant 2, an imbalance may nevertheless occur between the primary power P1 and the secondary power P2.

If the secondary power P2 is strictly less than the primary power P1, this can lead to a build-up of power in the primary circuit 4, which is undesirable.

Conversely, if the secondary power P2 is strictly greater than the primary power P1, this may lead to cooling of the reactor core 16, which is undesirable.

The power-limiting mode is designed to re-establish a balance between the primary power P1 and the secondary power P2 while keeping the nuclear power plant 2 in a normal operating zone, to avoid the intervention of a protection system that could be automatically activated to shut down the nuclear power plant 2 if it left a normal operating zone.

In the power-limiting mode, a target equilibrium power PEC is calculated by the control system 40, preferably independently of the operational power setpoint COP, the nuclear power plant 2 then being controlled as a function of the target equilibrium power PEC, and no longer as a function of the operational power setpoint COP.

The target equilibrium power PEC is calculated to be less than or equal to the primary power P1 and less than or equal to the secondary power P2, so that the power-limiting mode causes a drop in the primary power P1 and/or a drop in the secondary power P2, while bringing them back into balance.

The power-limiting mode is designed so that it can be implemented automatically using the control system 40 while remaining in a normal operating zone of the nuclear power plant 2, and therefore without the intervention of a protection system.

As mentioned above, any imbalance is detected by comparing a primary power signal S1 and a secondary power signal S2.

The primary power signal S1 is calculated so as to be representative of the primary power P1, while optionally being indicative of a change in the primary power P1.

The secondary power signal S2 is calculated so as to be representative of the secondary power P2, while optionally being indicative of a change in the secondary power P2.

By taking into account changes in the primary power P1 and/or changes in the secondary power P2, an imbalance can be anticipated.

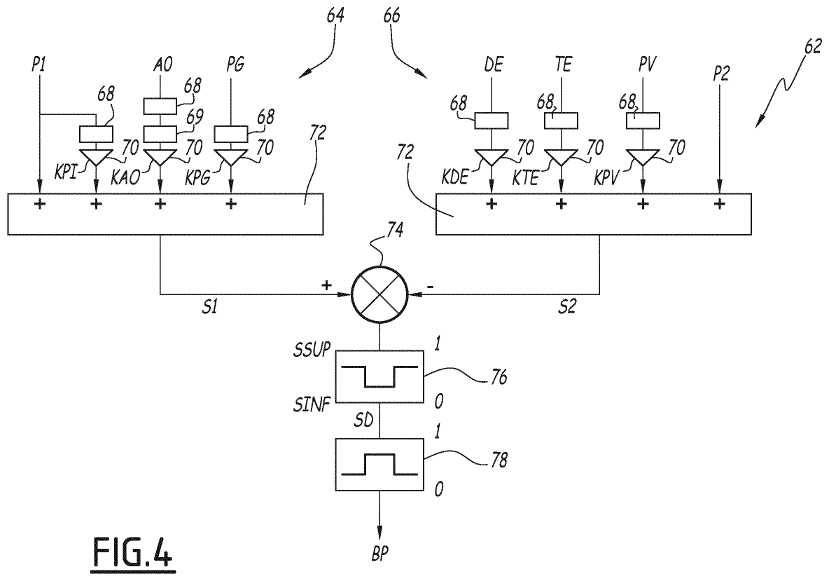

In one embodiment, as illustrated in FIG. 4, the primary power signal S1 is calculated for example as a function of the primary power P1, a filtered derivative of the primary power, an axial offset AO of the nuclear reactor 10, an absolute value of a filtered derivative of the axial offset of the nuclear reactor 10, a motion signal PG indicative of a motion by control clusters 20 and/or a filtered derivative of the control cluster 20 motion signal PG.

A “filtered” derivative is a derivative function combined with a filter that cuts off high-frequency variations and allows low-frequency variations to pass (low-pass filter).

Taking into account the derivative of a variable allows you to take into account the variation of this variable in order to anticipate a change.

The low-pass filter applied to the derivative enables the derivative to be smoothed so that only the trend in the variation of the magnitude indicated by the derivative is taken into account, without taking into account excessively rapid variations which are not representative of a real trend in the change in the signal.

In a known way, the axial offset AO of the nuclear reactor 10 is representative of a non-uniform distribution of the neutron flux along the assemblies of the nuclear reactor 10, in particular of an imbalance of the neutron flux between a lower part of the nuclear reactor 10 and an upper part of the nuclear reactor 10.

The axial offset AO can be determined, for example, using a set of neutron detectors 42 fitted to the nuclear reactor 10 and distributed vertically so that differences in the neutron flux can be measured as a function of their positions along the nuclear reactor 10.

A variation in the axial offset AO may indicate a future variation in the primary power P1. By taking into account the axial offset AO, in particular an absolute value of the filtered derivative of the axial offset AO, it is possible to anticipate a variation in the primary power P1.

A movement of control clusters 20 can lead to a variation in the primary power P1. By taking into account the motion signal PG, and in particular a filtered derivative of the motion signal PG, it is possible to anticipate a variation in the primary power P1 which would be due to a movement of the control clusters 20.

In one example, the primary power signal S1 is calculated as equal to the primary power P1.

In one variant, preferably, the primary power signal S1 is calculated as the sum of the primary power P1 and one or more of the filtered derivative of the primary power P1 multiplied by a primary power coefficient KP1, the absolute value of the filtered derivative of the axial offset AO of the nuclear reactor 10 multiplied by an axial offset coefficient KAO, and the filtered derivative PG of the control cluster motion signal multiplied by a cluster motion coefficient KPG.

Each of the above coefficients (primary power coefficient KP1, axial offset coefficient KAO and cluster motion coefficient KPG) is preferably positive or zero.

Each of the above coefficients (primary power coefficient KP1, axial offset coefficient KAO and cluster motion coefficient KPG) has its own value. The coefficients can have different values. In a very particular case, they may optionally be equal.

Coefficients are used to adjust the response of the control process as a function of the variables under consideration.

In the example shown in FIG. 4, the primary power signal S1 is calculated as the sum of the primary power P1, the filtered derivative of the primary power P1 multiplied by the primary power coefficient KP1, the absolute value of the filtered derivative of the axial offset AO of the nuclear reactor 10 multiplied by the axial offset coefficient KAO, and the filtered derivative PG of the control cluster motion signal multiplied by the cluster motion coefficient KPG.

The secondary signal S2 is calculated, for example, as a function of the secondary power P2, a steam pressure representative PV of the steam pressure at the outlet of the steam generator(s) 8, a filtered derivative of the steam pressure PV, a feedwater temperature TE representative of the water temperature at the inlet of the steam generator(s) 8, a filtered derivative of the feedwater temperature TE, a feedwater flow rate DE representative of the feedwater flow rate at the inlet of the steam generator(s) 8, and/or a filtered derivative DE of the feedwater flow rate.

When the nuclear power plant 2 comprises a plurality of steam generators 8, preferably, the steam pressure PV is determined as the average of the steam pressures at the outlet of the steam generators 8, determined for example using steam pressure sensors 44.

Alternatively, or when the nuclear power plant 2 comprises a single steam generator 8, it is determined as equal to the steam pressure PV at the outlet of the steam generator(s) 8 of the nuclear power plant 2

When the nuclear power plant 2 comprises a plurality of steam generators 8, preferably, the feedwater temperature TE is determined as the average of the feedwater temperatures at the inlet of the steam generators 8, determined for example using water temperature sensors 46.

Alternatively, or when the nuclear power plant 2 comprises a single steam generator 8, it is determined as equal to the water temperature at the inlet of the steam generator(s) 8 of the nuclear power plant 2.

When the nuclear power plant 2 comprises a plurality of steam generators 8, preferably, the incoming water flow rate DE is determined as the average of the water flow rates at the inlet of the steam generators 8, determined for example using water flow sensors 48.

Alternatively, or when the nuclear power plant 2 comprises a single steam generator 8, it is determined as equal to the water flow rate at the inlet of the steam generator(s) 8 of the nuclear power plant 2.

By taking into account the steam pressure PV, the feedwater temperature TE and/or the feedwater flow rate DE, and in particular the filtered derivative of one or more of these parameters, it is possible to anticipate a variation in the secondary power P2.

In one embodiment, the secondary power signal S2 is calculated as the sum of the secondary power P2 and one or more of the filtered derivative of the steam pressure PV multiplied by a steam pressure coefficient KPV which is preferably negative or zero, the filtered derivative of the feedwater temperature TE multiplied by a water temperature coefficient KTE which is preferably negative or zero, and the filtered derivative of the feedwater flow DE multiplied by a feedwater flow coefficient KDE which is preferably positive or zero.

As shown in FIG. 4, the secondary power signal S2 is calculated as the sum of the secondary power P2 and one or more of the filtered derivative of steam pressure PV multiplied by a steam pressure coefficient KPV, the filtered derivative of the feedwater temperature TE multiplied by a water temperature coefficient KTE, and the filtered derivative of feedwater flow DE multiplied by a feedwater flow coefficient KDE.

The low-pass filters used to calculate the different filtered derivatives used to calculate the primary power signal S1 and the secondary power signal S2 can be identical. In one variant, they are not all identical. At least two of these low-pass filters are different. In one particular example embodiment, they are all different.

As illustrated in FIG. 4, the electronic control unit 50 comprises a detection module 62 configured to detect an imbalance by determining and comparing the primary power signal S1 and the secondary power signal S2.

The detection module 62 comprises a primary signal module 64 and a secondary signal module 66 for calculating the primary power signal S1 and the secondary power signal S2 respectively.

The primary signal module 64 and the secondary signal module 66 each comprise one or more derivators 68, each derivator 68 being configured to receive a signal representative of a magnitude and to output the derivative of this signal, optionally an absolute value module 69 to receive the derivative of the axial offset AO and to output the absolute value of this derivative, one or more amplifiers 70, each multiplier being configured to multiply a signal by a zero, positive or negative coefficient, and two adders 72 for calculating the primary power signal S1 and the secondary power signal S2 from the signals taken into account for calculating both the primary power signal S1 and the secondary power signal S2.

In an example embodiment of the control method, and as illustrated in FIG. 4, the comparison of the primary power signal S1 and the secondary power signal S2 comprises calculating the difference between the primary power signal S1 and the secondary power signal S2 and comparing this difference with a lower threshold SINF and/or an upper threshold SSUP and switching from a setpoint-following mode to the power-limiting mode.

The control method comprises, for example, switching from setpoint-following mode to power-limiting mode when the difference between the primary power signal S1 and the secondary power signal S2 is less than the lower threshold SINF and/or greater than the upper threshold SSUP.

For example, the transition to power-limiting mode is timed so that the power-limiting mode is maintained for at least a determined power-limiting time beginning from the moment it is activated.

The determined power-limiting time is predetermined, for example. For example, it is greater than or equal to 10 seconds(s), in particular greater than or equal to 20 seconds.

Maintaining the power-limiting mode for a certain minimum time allows the primary power P1 and the secondary power P2 to be effectively reduced and rebalanced, without switching too quickly to the setpoint-following mode, even if the primary power P1 and the secondary power P2 have quickly returned to a balanced situation.

To switch from setpoint-following mode to power-limiting mode, the control method comprises, for example, the generating of an imbalance logic signal SD indicative of the existence of an imbalance between the primary power signal S1 and the secondary power signal S2, and of a timed rebalancing request logic signal BP, determined as a function of the imbalance logic signal, to order the switch to power-limiting mode.

The imbalance logic signal SD adopts two values (e.g. 0 or 1), one indicating the existence of a significant imbalance requiring a switch to power-limiting mode, and the other indicating the absence of a significant imbalance requiring a switch to setpoint-following mode.

The rebalancing request logic signal BP adopts two values (e.g. 0 or 1), one corresponding to setpoint-following mode and the other to power-limiting mode, the rebalance request logic signal BP being timed so that when it changes to the value corresponding to power-limiting mode, this value is maintained for the determined power-limiting time.

As illustrated in FIG. 4, the control module comprises, for example, a subtractor 74 arranged to determine the difference between the primary power signal S1 and the secondary power signal S2, a comparator 76 to compare the difference with the inner threshold SINF and/or the upper threshold SSUP and to generate the imbalance logic signal SD as a function of the result of the comparison, and a limit request generator 78 to generate the rebalance request logic signal BP as a function of the imbalance logic signal SD.

Advantageously, the target equilibrium power PEC is calculated as a function of a maximum equilibrium power PEMAX, the target equilibrium power PEC being less than or equal to the maximum equilibrium power PEMAX.

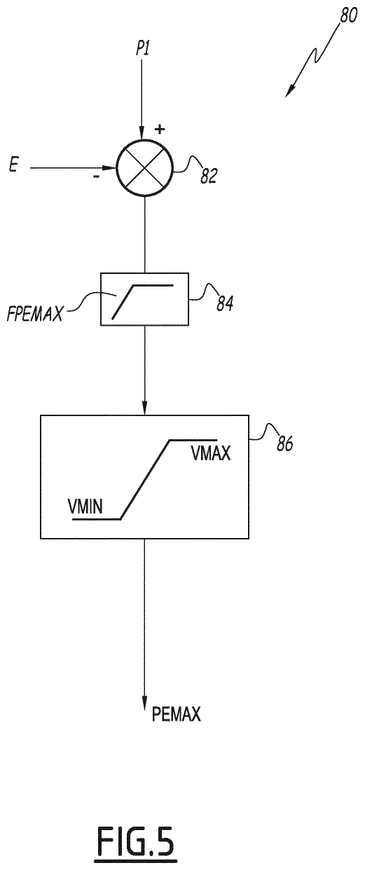

As shown in FIG. 5, the control method involves calculating the maximum equilibrium power PEMAX as a function of the primary power P1.

Advantageously, the maximum equilibrium power PEMAX is calculated from the primary power P1 minus a non-zero difference E. This makes it possible to determine a power value that is strictly lower than the primary power P1, for example in order to then calculate power setpoints (primary power setpoint CP1 and secondary power setpoint CP2 as will be described later) that allow the power of the nuclear reactor 10 to be reduced.

The value of the difference E is, for example, between 20% and 55% of the nominal operating power of the nuclear reactor 10, in particular between 20% and 35% of the nominal operating power of the nuclear reactor 10.

The nominal operating power of the nuclear reactor 10 is its maximum permitted power in normal operation. This is a predetermined power for the nuclear reactor 10.

In one example, the distance E is constant. In one particular example, the difference E is chosen to be equal to 25% of the nominal power PN of the nuclear reactor 10.

In practice, it has been found that the range of values indicated above for the difference E makes it possible to reduce the power by allowing a balance to be restored after an imbalance between the primary power P1 and the secondary power P2 has been detected.

Preferably, the difference between the primary power P1 and the difference E is filtered using a maximum equilibrium power filter FPEMAX so that the absolute value of its derivative remains below a determined derivative threshold. The FPEMAX maximum equilibrium power filter is, for example, a low-pass filter, in particular a second-order low-pass filter. It may be another type of filter.

This makes it possible to determine a maximum equilibrium power PEMAX from a signal (difference between the primary power and the filtered difference E) whose derivative is limited and consistent with the load monitoring of the nuclear reactor 10, i.e. with its reactivity during a change in power setpoint.

Preferably, the FPEMAX maximum equilibrium power filter is configured so that the absolute value of the derivative of the difference between the primary power P1 and the difference E remains less than a maximum absolute value of the load following derivative, for example 5% of the nominal power PN per minute.

As an option, preferably after filtering when any is carried out, the signal resulting from the difference between the primary power P1 and the difference E is clipped between a minimum value VMIN and/or a maximum value VMAX.

This ensures that the maximum equilibrium power PEMAX remains higher than the minimum value VMIN and/or lower than the maximum value VMAX whatever the current primary power P1 on the basis of which the maximum equilibrium power PEMAX is determined, to take account, for example, of a situation where the primary power P1 is momentarily greater than the nominal power PN.

The minimum value VMIN is, for example, equal to zero and the maximum value VMAX is, for example, equal to 75% of the nominal power PN of the nuclear reactor 10.

As illustrated in FIG. 5, the control module 56 of the electronic control unit 50 comprises, for example, a maximum power calculation module 80 configured to calculate the maximum target equilibrium power PEMAX.

As illustrated in FIG. 5, this maximum power calculation module 80 comprises, for example, a subtractor 82 for receiving as input the primary power P1 and subtracting from it the difference E, and, optionally, in series with the subtractor 82, a filtering module 84 for applying the maximum equilibrium power filter FPEMAX to the primary power P1 reduced by the difference E and/or a clipping module 86 receiving as input the primary power P1 reduced by the difference E, optionally filtered by the filtering module 84.

The target equilibrium power PEC is determined as a function of the primary power P1, the secondary power P2 and the maximum target equilibrium power PEMAX, so as to be less than or equal to each of them.

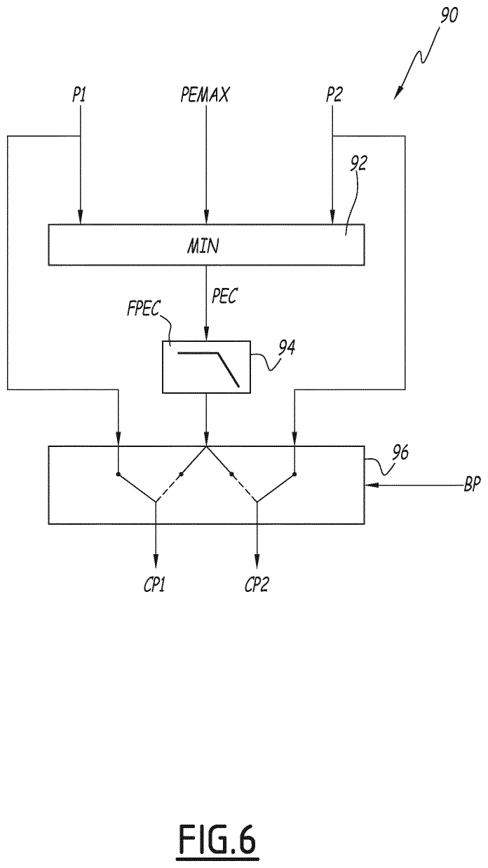

As shown in FIG. 6, in one example embodiment of the control method, the target equilibrium power PEC is determined as the minimum of the primary power P1, the secondary power P2 and the maximum equilibrium power PEMAX.

The control method comprises, for example, in power-limiting mode, calculating a primary power setpoint CP1 and a secondary power setpoint CP2, and controlling the nuclear power plant 2 in such a way that the primary power P1 matches the primary power setpoint CP1 (i.e. so as to limit a difference between the primary power P1 and the primary power setpoint CP1) and the secondary power matches the primary power setpoint CP2 (i.e. so as to limit a difference between the primary power P1 and the secondary power setpoint CP2). The primary power setpoint CP1 and the secondary power setpoint CP2, used to control the nuclear power plant 2 in power-limiting mode, are calculated as a function of the target equilibrium power PEC.

In a particular embodiment, the primary power setpoint CP1 and the secondary power setpoint CP2 are calculated as equal to the target equilibrium power PEC, optionally filtered by applying a target equilibrium power filter FPEC, which is preferably a low-pass filter.

The control module 56 of the electronic control unit 50 comprises, for example, a setpoint calculation module 90 configured to calculate the primary power setpoint CP1 and the secondary power setpoint CP2.

The setpoint calculation module 90 receives as input the primary power P1, the secondary power P2 and the maximum equilibrium power PEMAX, and outputs the primary power setpoint CP1 and the secondary power setpoint CP2.

The setpoint calculation module comprises, for example, a selector 92 configured to select the signal with the lowest value from the primary power P1, the secondary power P2 and the maximum equilibrium power PEMAX.

Optionally, the control unit 50 comprises an equilibrium power filtering module 94 for filtering the target equilibrium power PEC, by applying the target equilibrium power filter FPEC.

Optionally, in setpoint-following mode, the control method comprises calculating the primary power setpoint CP1 and the secondary power setpoint CP2 as being equal to the primary power P1 and the secondary power P2 respectively.

In setpoint-following mode, the primary power setpoint CP1 and the secondary power setpoint CP2 calculated in this way are not in principle used for the actual control of the nuclear power plant 2, which is carried out as a function of the operational power setpoint COP.

However, this provides a safeguard in the event that the control system 40 accidentally switches to power-limiting mode without actually detecting a power imbalance. In such a case, the logical rebalancing request signal BP would not request switching to power-limiting mode, so that the primary power setpoint CP1 would be taken as equal to the primary power P1 and the secondary power setpoint CP2 would be taken as equal to the secondary power P2, so that the control system 40 would not modify the primary power P1 and the secondary power P2 despite accidentally switching to power-limiting mode.

The setpoint calculation module 90 comprises, for example, a switching module 96 receiving as input the primary power P1, the secondary power P2 and the target equilibrium power PEC, possibly filtered, and outputting the primary power setpoint CP1 and the secondary power setpoint CP2, the switching module 96 being controlled by the rebalancing request logic signal BP, in such a way that the primary power setpoint CP1 is equal to the primary power in setpoint-following mode or to the target equilibrium power PEC, possibly filtered, in power-limiting mode, and that the secondary power setpoint CP2 is equal to the secondary power in setpoint-following mode and to the target equilibrium power PEC, possibly filtered, in power-limiting mode.

In one example embodiment, each module and/or each filter of the electronic control unit 50 is implemented in the form of a software application comprising software code instructions that can be stored on a computer memory or a medium and executed by a processor.

Alternatively, at least one module and/or at least one filter of the electronic control unit 50 is in the form of an ASIC (Application-Specific Integrated Circuit) or a programmable logic circuit, for example an FPGA (Field-Programmable Gate Array).

In operation, by default, the control system 40 controls the nuclear power plant 2 in setpoint-following mode, wherein the nuclear power plant 2 is controlled so that the primary power P1 and the secondary power P2 follow the operational power setpoint.

If an imbalance is detected by comparing the primary power signal S1 and the secondary power signal S2, the control system 40 switches to the power-limiting mode in which the primary power P1 and the secondary power P2 are controlled as a function of a target equilibrium power PEC calculated by the control system 40 and less than or equal to both the primary power P1 and the secondary power P2.

During the power-limiting mode, the control system 40 calculates, for example, a primary power setpoint CP1 and a secondary power setpoint CP2 from the target equilibrium power PEC, and controls the nuclear power plant in such a way that the primary power P1 matches the primary power setpoint CP1 and the secondary power P2 matches the secondary power setpoint CP2.

The primary power setpoint CP1 is, for example, equal to the target equilibrium power PEC, possibly filtered, in particular by a low-pass filter, and the secondary power setpoint CP2 is, for example, equal to the target equilibrium power PEC, possibly filtered, in particular by a low-pass filter.

The power-limiting mode is maintained for the determined power-limiting time before returning to setpoint-following mode.

Optionally, in setpoint-following mode, the control system 40 calculates the primary power setpoint CP1 as equal to the primary power P1 and calculates the secondary power setpoint CP2 as equal to the secondary power P2.

By virtue of the present disclosure, it is possible to keep the nuclear power plant 2 in a normal operating range in the event of a power imbalance, by switching to a power-limiting mode implemented by the control system 40 which already controls the nuclear power plant 2 in setpoint-following mode, and by avoiding the intervention of a protection system, the function of which is to shut down the nuclear power plant, for example by causing safety clusters to descend.

The power-limiting mode can be implemented at all power levels of the nuclear power plant, i.e. whatever the current operational power setpoint when an imbalance is detected.

It can be implemented using the 40 control system. It can be activated on high-amplitude normal operating transients or on incidental transients from the nuclear power plant 2, leading to a significant power imbalance.

It can be carried out without intervention by the protection system, and in particular is not restricted to the use of protection system instruments. In the absence of any intervention by the protection system in the nuclear power plant 2, the safety report for the nuclear power plant 2 is considered to be only slightly affected. The implementation of the specific control method does not require the safety report for the nuclear power plant 2 to be redrafted, except for the revision of chapters of the safety report specific to transients modified by the innovation or to certain projects in which limiting systems are considered.

The present disclosure is not limited to the above-mentioned example embodiments and variants, as other embodiments and variants are possible.

For example, in the embodiment shown in FIG. 6, in power-limiting mode, the primary power setpoint P1 and the secondary power setpoint P2 are both calculated as the target equilibrium power PEC filtered by the same target equilibrium power filter PEC.

Alternatively, it is possible to provide a primary filter and a secondary filter that are different from each other, the primary power setpoint CP1 being equal to the target equilibrium power PEC filtered by the primary filter and the secondary power setpoint CP2 being equal to the target equilibrium power PEC filtered by the secondary filter.

It is also possible to provide a primary filter and a secondary filter that are identical, the primary power setpoint CP1 being equal to the target equilibrium power PEC filtered by the primary filter and the secondary power setpoint CP2 being equal to the target equilibrium power PEC filtered by the secondary filter.

Furthermore, the calculation of the primary power P1 and the calculation of the secondary power P2 are not limited to the calculation examples shown above, as other ways of calculating the primary power P1 and the secondary power P2 are also possible.

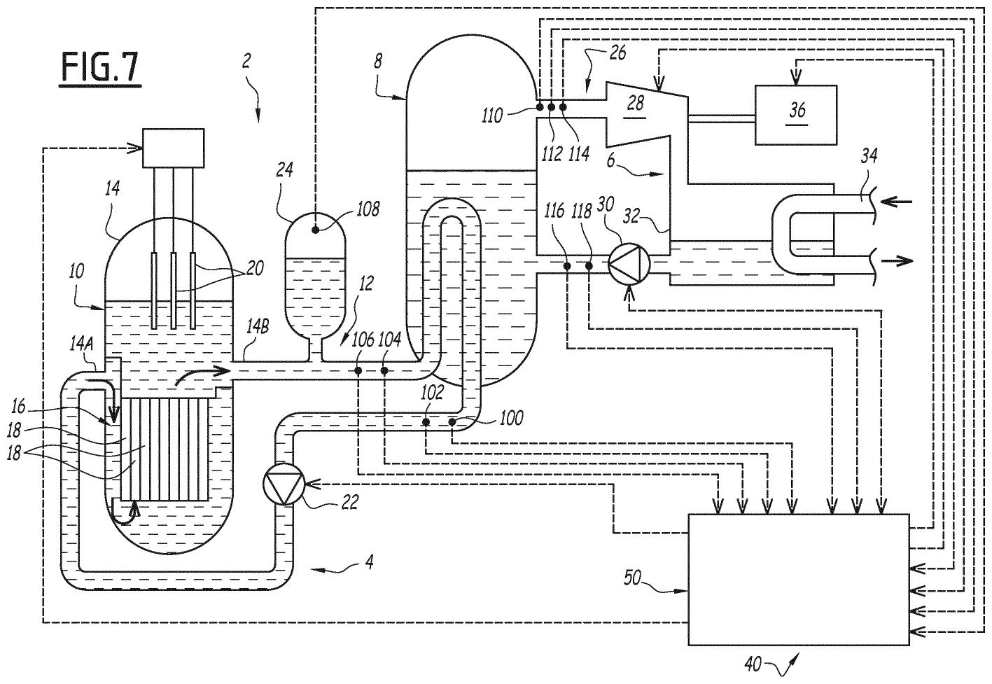

In one embodiment, as illustrated in FIG. 7 where numerical references to elements similar to those in FIGS. 1 to 6 have been retained, the first sensors, whose measurements are used to calculate the primary power P1, comprise for example:
in each cold leg of the primary circuit 4, a cold leg temperature sensor 100 for measuring the temperature of the water circulating in this cold leg and a cold leg flow rate sensor 102 for measuring the flow rate of the water circulating in this cold leg,
in each hot leg of the primary circuit 4, a hot leg temperature sensor 104 for measuring the temperature of the water circulating in this hot leg and a hot leg flow rate sensor 106 for measuring the flow rate of water circulating in this hot leg, and
a pressuriser pressure sensor 108 for measuring the pressure in the pressuriser 24.

The calculation of the primary power P1, carried out by a primary power calculation module of an electronic control unit 50, then comprises, for example:
calculating an average cold leg temperature TBFM as the average of the cold leg temperatures measured by the cold leg temperature sensors 100, optionally after filtering using a filter, preferably a low-pass filter,
calculating an average cold leg flow rate DBFM as the average of the cold leg flow rates measured by the cold leg flow rate sensors 102, optionally after filtering using a filter, preferably a low-pass filter,
calculating an average hot leg temperature TBCM as the average of the hot leg temperatures measured by the hot leg temperature sensors 104, optionally after filtering using a filter, preferably a low-pass filter,
calculating an average hot leg flow rate DBCM as the average of the hot leg flow rates measured by the hot leg flow rate sensors 106, optionally after filtering using a filter, preferably a low-pass filter; and
calculation of the primary power P1 as a function of the average cold leg temperature TBFM, the average cold leg flow rate DBFM, the average hot leg temperature TBCM and the average hot leg flow rate DBCM.

The calculation of the primary power P1, carried out by the primary power calculation module of the electronic control unit 50, comprises, for example
calculating an average cold leg enthalpy HBFM as a function of the average cold leg temperature and the pressurizer pressure PPR measured by the pressurizer pressure sensor 108,
calculating an average hot leg enthalpy HBCM as a function of the average hot leg temperature TBCM and the pressurizer pressure PPR; and
calculating the primary power P1 as equal to an average primary thermal power supplied by the nuclear reactor to the primary circuit 4, the average primary thermal power being calculated as the product of a calibration coefficient K and a function for calculating the primary thermal power FPTH, using as input data the average cold leg flow rate DBFM, the average hot leg flow rate DBCM, the average cold leg enthalpy HBFM, the average hot leg enthalpy HBCM, the average hot leg enthalpy HBCM, the average cold leg temperature TBFM, the average hot leg temperature TBCM and the pressuriser pressure PPR.

The function for calculating the primary heat output FPTH is preferably based on the heat balance of the primary circuit 4.

The calibration coefficient K is determined during a periodic test using the secondary enthalpy balance required to determine the thermal output. It is used to adjust the primary thermal output.

In this way, a primary power P1 can be determined on the basis of measurements provided by temperature sensors, flow rate sensors and a pressure sensor, instead of using neutron sensors 42, for example.

In one embodiment, as illustrated in FIG. 7, the second sensors, whose measurements are used to calculate the secondary power P2, comprise for example, for each steam generator 8, a steam flow sensor 110 for measuring the flow of steam in the secondary circuit 6 at the outlet of the steam generator 8, a steam pressure sensor 112 for measuring the pressure in the secondary circuit 6 at the outlet of the steam generator 8, a steam temperature sensor 114 for measuring the temperature in the secondary circuit 6 at the outlet of the steam generator 8, a water pressure sensor 116 for measuring the pressure of the water entering the steam generator 8 in the the liquid state in the secondary circuit 6 and a water temperature sensor 118 for measuring the temperature of the water at the inlet to the steam generator 8 in the secondary circuit 6.

The calculation of the primary power P2, carried out by the secondary power calculation module of the electronic control unit 50, comprises, for example:
for each steam generator 8, calculating an input enthalpy HE as a function of the water temperature TEAU and the water pressure PEAU at the inlet of the steam generator 8 measured by the water temperature sensor 118 and the water pressure sensor 116 and calculating an output enthalpy HV as a function of the steam temperature and the steam pressure at the outlet of the steam generator measured by the steam temperature sensor 114 and the steam pressure sensor 112, and
calculating a secondary power P2 as the sum of the product, for each steam generator 8, of the steam flow rate DV at the outlet of that steam generator measured by the steam flow sensor 110, by the difference between the output enthalpy HV of that steam generator and the input enthalpy HE of that steam generator.

The primary power P2 is thus calculated according to the following equation:

$$P 2 = {\sum }_{i} D {V}_{i} \times ( H {V}_{i} - H {E}_{i} )$$

in which
P2 is the secondary power in watts (W),
i is the index of the steam generator,
Dviᵢ is the steam flow rate at the outlet of the steam generator 8 of index i in kilograms per second (kg/s),
HVᵢ is the output enthalpy of the steam generator 8 of index i in joules per kilogram (J/kg), and
HEᵢ is the input enthalpy of the steam generator 8 of index i in joules per kilogram (J/kg).

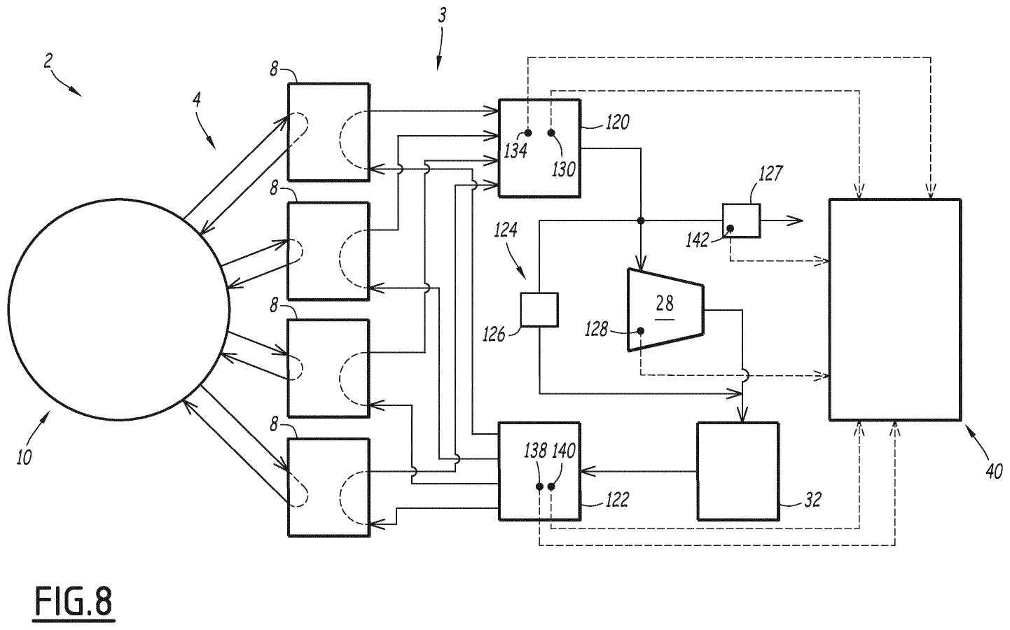

As illustrated in FIG. 8, where numerical references to elements similar to those in FIGS. 1 to 7 have been retained, a secondary circuit 6 having a plurality of steam generators 8 feeding the same turbine 28 comprises for example a steam drum 120 (or “steam collector”) receiving the steam productions of the steam generators 8 and distributing the steam produced to the turbine 28, and a water drum 122 (or “water distributor”) receiving the water exiting the condenser 32 and distributing this water to the various steam generators 8.

In addition, the secondary circuit 6 comprises, for example, a circuit for evacuating steam from the secondary by bypassing the turbine 28, hereinafter referred to by the acronym SDBCS for “Steam Dump and Bypass Control System”, associated with the numerical reference 124. The SDBCS 124 is configured to direct steam from the outlet of the steam drum 120 to the inlet of the condenser 32, bypassing the turbine 28.

The SDBCS 124 comprises for example one or more control actuators 126 for controlling the flow of steam through the SDBCS 124, such as valves, controlled by the control system 40 of the nuclear power plant, for example via a logic locking signal SDBCS_dev taking two values (for example 0 and 1), one not allowing opening and requesting locking of the SDBCS 124, and the other allowing opening and requesting unlocking of the SDBCS, and an opening control signal SDBCS_com requesting opening of the valves of the SDBCS 124, for example as a percentage of opening between a minimum opening and a maximum opening.

The nuclear power plant includes, for example, one or more steam-consuming devices 127. Each steam-consuming device 127 is connected to the secondary circuit 6 to draw steam from the secondary circuit 6, preferably at the outlet of the steam drum 120.

A steam-consuming device 127 is, for example, the equipment known as the “dryer-superheater”.

The steam-consuming devices 127 do not include the turbine 28 and the SDBCS 124.

In one embodiment, as illustrated in FIG. 8, the second sensors comprise for example:
a turbine pressure sensor 128 configured to measure a pressure in the turbine 28, preferably to measure the pressure at the inlet of the first wheel of the turbine 28 when the turbine 28 comprises a plurality of wheels each defining a turbine stage,
a pressure sensor at the steam drum 130 to measure the pressure of the steam in the steam drum,
a steam drum temperature sensor 134 to measure the temperature of the steam in the steam drum,
a water drum temperature sensor 138 to measure the temperature of the water in the steam drum,
a water drum pressure sensor 140 to measure the pressure of the water in the steam drum;
one or more steam withdrawal rate sensors 142, each steam withdrawal rate sensor measuring the rate of steam withdrawn from the secondary circuit 6 by a steam-consuming device 127.

The primary power P2 is for instance calculated according to the following equations:
if the SDBCS is unlocked:

$$P 2 = F ( P 1 TR ) + \text{} [ ( {K}_{GCTC} \times PBVAP \times GCTCcom ) + {\sum }_{j} ( {K}_{j} \times {D}_{j} ) ] \times ( HBVAP - HBEAU )$$

if the SDBCS is locked:

$$P 2 = F ( P 1 TR ) + [ {\sum }_{j} ( {K}_{j} \times {D}_{j} ) ] \times ( HBVAP - HBEAU )$$

in which:
P2 is the secondary power in W,
P1TR is the pressure measured at the inlet to the first turbine wheel 28 in Pascals (Pa),
F(P1TR) is a function giving the thermal power transmitted to the turbine 28 from the pressure measurement at the inlet to the first turbine wheel 28,
PBVAP is the steam pressure at steam drum 120 in Pa
HBVAP is the enthalpy of steam at steam drum 120 in J/kg,
HBEAU is the enthalpy of water at the water drum 122 in J/kg,
SDBCS_com is the opening control signal of the SDBCS 124, expressed as a percentage of opening, with 100% opening corresponding to maximum opening and 0% to minimum opening,
KSDBCS is an adjustment coefficient for the thermal power evacuated at SDBCS 124 expressed in W/(Pa×% opening of SDBCS 124),
Dⱼ is the mass flow rate of steam consumed by the steam-consuming device of index j expressed in kg/s, and
Kⱼ is an adjustment coefficient for the thermal power discharged to the steam-consuming device of index j.

Such a calculation of a secondary power P2 is carried out in particular by means of sensors arranged on the steam drum 120 and on the water drum 122 without it being necessary to equip each steam generator with one or more sensors at the inlet of the steam generator 8 and at the outlet of the steam generator 8. The number of sensors may be limited.

What is claimed is:

1-19. (canceled)

20. A method for controlling a pressurized water nuclear power plant implemented by an automated control system, the nuclear power plant comprising a primary circuit for circulating water, incorporating a nuclear reactor, a secondary circuit for circulating water, and N steam generator(s), N being an integer greater than or equal to 1, each steam generator being configured to transfer thermal energy from the primary circuit to the secondary circuit with steam being generated in the secondary circuit, the control method comprising:
calculating a primary power representative of a thermal power generated by the nuclear reactor, the primary power being calculated as a function of measurements of first operating parameters of the nuclear power plant, relating to the operation of the primary circuit and measured by first sensors, and of a secondary power representative of the thermal power transferred from the primary circuit to the secondary circuit by the steam generator(s), the secondary power being calculated as a function of second operating parameters of the nuclear power plant, relating to the operation of the secondary circuit and measured by second sensors;
detecting any imbalance between, on the one hand, a primary power signal calculated as a function of the primary power and/or at least one variable indicative of a variation in the primary power and, on the other hand, a secondary power signal calculated as a function of the secondary power and/or at least one variable indicative of a variation in the secondary power;
in an absence of detection of an imbalance, implementing a setpoint-following mode, wherein the nuclear power plant is controlled as a function of an operational power setpoint received by the control system so that the primary power and the secondary power follow the operational power setpoint; and
if an imbalance is detected, automatically implementing a power-limiting mode, comprising calculation, by the control system, of a target equilibrium power less than or equal to the primary power and less than or equal to the secondary power, and control of the nuclear power plant as a function of the target equilibrium power.

21. The control method according to claim 20, wherein the secondary power is determined by calculating a thermal power transferred by each steam generator from the primary circuit to the secondary circuit and by calculating a sum of these thermal powers.

22. The control method according to claim 20, wherein the primary power signal is calculated as a function of the primary power, a filtered derivative of the primary power, an axial offset of the nuclear reactor, a filtered derivative of the axial offset of the nuclear reactor, a control cluster motion signal and/or a filtered derivative of the control cluster motion signal.

23. The control method according to claim 22, wherein the primary power signal is calculated as a sum of the primary power and one or more of the filtered derivative of the primary power multiplied by a primary power coefficient, an absolute value of the filtered derivative of the axial offset multiplied by an axial offset coefficient, and the filtered derivative of the control cluster motion signal multiplied by a motion signal coefficient.

24. The control method according to claim 20, wherein the secondary power signal is calculated as a function of the secondary power, a steam pressure representative of the steam pressure at an outlet of the steam generator(s), a filtered derivative of the steam pressure, a feedwater temperature representative of a water temperature at an inlet of the steam generator(s), a filtered derivative of the feedwater temperature, a feedwater flow rate representative of the feedwater flow rate at the inlet of the steam generator(s), and/or a filtered derivative of the feedwater flow rate.

25. The control method according to claim 24, wherein the secondary power signal is calculated as a sum of the secondary power and one or more among the filtered derivative of the steam pressure multiplied by a steam pressure coefficient, the filtered derivative of the feedwater temperature multiplied by a feedwater temperature coefficient, and the filtered derivative of feedwater flow multiplied by a feedwater flow coefficient.

26. The control method according to claim 20, wherein the detection of any imbalance comprises comparing a difference between the primary power signal and the secondary power signal with a lower threshold and/or an upper threshold.

27. The control method according to claim 26, wherein detecting any imbalance comprises the generating of a rebalancing request logic signal when said difference is less than the lower threshold and/or greater than the upper threshold, ordering a switch to the power-limiting mode.

28. The control method according to claim 20, wherein the power-limiting mode is activated for a power-limiting time determined from the detection of an imbalance.

29. The control method according to claim 20, wherein the target equilibrium power is calculated as a function of a maximum equilibrium power, the target equilibrium power being less than or equal to the maximum equilibrium power.

30. The control method according to claim 29, wherein the maximum equilibrium power is calculated as a function of the primary power minus a non-zero difference.

31. The control method as claimed in claim 30, wherein the primary power minus the difference is filtered so that an absolute value of its derivative remains below a determined derivative threshold.

32. The control method according to claim 30, comprising clipping in such a way that the maximum equilibrium power is less than a determined maximum value and/or greater than a determined minimum value.

33. The control method according to claim 29, wherein the target equilibrium power is determined as a minimum of the primary power, the secondary power and the maximum equilibrium power.

34. The control method according to claim 20, comprising, in the power-limiting mode, calculating a primary power setpoint and a secondary power setpoint as a function of the target equilibrium power, and controlling the nuclear power plant in such a way that the primary power matches the primary power setpoint and the secondary power matches the secondary power setpoint.

35. The control method according to claim 34, wherein, in the power-limiting mode, the primary power setpoint is calculated as equal to the target equilibrium power, optionally filtered, preferably by a low-pass filter, and the secondary power setpoint is calculated as equal to the target equilibrium power, optionally filtered, preferably by a low-pass filter.

36. A system for controlling a nuclear power plant, configured to implement the control method according to claim 20.

37. A nuclear power plant comprising a primary circuit for circulating water, incorporating a nuclear reactor, a secondary circuit for circulating water, and N steam generator(s), N being an integer greater than or equal to 1, each steam generator being configured to transfer thermal energy from the primary circuit to the secondary circuit with steam being generated in the secondary circuit, the nuclear power plant comprising the control system according to claim 36.

38. A computer program product on a non-transitory computer readable medium or in a computer memory and executable by a processor, said computer program product containing software code instructions for implementing the control method according to claim 20.
